(19) United States
(12) Patent Application Publication
(10) Pub. No.: US 2022/0414297 A1
(43) Pub. Date: Dec. 29, 2022

(54) CLOSED-LOOP FEEDBACK FOR ADDITIVE MANUFACTURING SIMULATION

(71) Applicant: UNIVERSITY OF WASHINGTON, Seattle, WA (US)

(72) Inventors: Dan WANG, Seattle, WA (US); Xu CHEN, Seattle, WA (US)

(21) Appl. No.: 17/775,657

(22) PCT Filed: Nov. 13, 2020
(86) PCT No.: PCT/US2020/060465

§ 371 Date: May 10, 2022

Related U.S. Application Data
(60) Provisional application No. 62/935,213, filed on Nov. 14, 2019.

(51) Int. Cl. G06F 30/23; G06F 30/28

(52) U.S. Cl. CPC G06F 30/23; G06F 30/28

(57) ABSTRACT

In an example, a method includes processing an input signal using a finite element model (FEM) to generate an output signal. The input signal, the output signal, and the FEM are associated with a simulated additive manufacturing process. The method also includes adjusting the input signal based on comparing the output signal to a reference signal and thereafter processing the input signal using the FEM to generate the output signal. Examples also include a computer readable medium and a computing device related to the method.

### CROSS-REFERENCE TO RELATED APPLICATION

This application claims priority to U.S. Provisional Patent Application No. 62/935,213, filed on Nov. 14, 2019. the entire contents of which are incorporated herein by reference.

Also incorporated by reference herein is “Closed-Loop High-Fidelity Simulation Integrating Finite Element. Modeling With Feedback Controls in Additive Manufacturing,” Dan Wang, Xu Chen, J. Dyn. Sys., Meas., Control February 2021, 143(2): 021006, https://doi.org110,1115/1.4048364.

### FEDERAL FUNDING STATEMENT

This invention was made with government. support under Grant No. 1953155 awarded by the National Science Foundation. The government has certain rights in the invention

### BACKGROUND

Distinct. from conventional subtractive machining, additive manufacturing (AM) involves forming a component by joining materials layer by layer. Examples of All include vat photopolymerization, material jetting, binder jetting, powder bed fusion (PBF), material extrusion, directed energy deposition, and sheet lamination. PBF involves using lasers or electron beams to fuse a powder precursor material layer by layer to form a component. In general, AM methods can be hampered by insufficient reliability and undesirable in-process variations.

### SUMMARY

In a first aspect of the disclosure, a method comprises: processing an input signal using a finite element model (FEM) to generate an output signal, wherein the input signal, the output signal, and the FEM are associated with a simulated additive manufacturing process; adjusting the input signal based on comparing the output signal to a reference signal; and thereafter processing the input signal using the FEM to generate the output signal.

In a second aspect of the disclosure, a computer readable medium stores instructions that, when executed by a computing device, cause the computing device to perform functions comprising: processing an input signal using a finite element model (FEM) to generate an output signal, wherein the input signal, the output signal, and the FEM are associated with a simulated additive manufacturing process; adjusting the input signal based on comparing the output signal to a reference signal; and thereafter processing the input signal using the FEM to generate the output signal.

In a third aspect of the disclosure, a computing device comprises: a processor; and a computer readable medium storing instructions that, when executed by the processor, cause the computing device to perform functions comprising: processing an input signal using a finite element model (FEM) to generate an output signal, wherein the input signal, the output signal, and the FEM are associated with a simulated additive manufacturing process; adjusting the input signal based on comparing the output signal to a reference signal; and thereafter processing the input signal using the FEM to generate the output signal.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that. do not preclude the effect the characteristic was intended to provide. In some examples disclosed herein, “substantially” or “about” means within +/−0-5% of the recited value.

These, as well as other aspects, advantages, and alternatives will become apparent to those of ordinary skill in the art by reading the following detailed description, with reference where appropriate to the accompanying drawings, Further, it should be understood. that this summary and other descriptions and figures provided herein are intended to illustrate the invention by way of example only and, as such, that. numerous variations are possible.

### BRIEF DESCRIPTION OF THE DRAWINGS

FIG. 1 is a schematic diagram of a computing device, according to an example embodiment.

FIG. 2 is a block diagram of a closed-loop control applied to a simulated additive manufacturing process, according to an example embodiment,

FIG. 3 is a schematic diagram of a trajectory of an energy beam, according to an example embodiment.

FIG. 4 is a block diagram of a closed-loop control applied to a simulated additive manufacturing process, according to an example embodiment.

FIG. 5 is block diagram of a simulated additive manufacturing process using closed-loop control, according to an example embodiment.

FIG. 6 is a block diagram of a method, according to an example embodiment.

### DETAILED DESCRIPTION

As noted above, more reliable and predictable AM methods and devices for implementing such methods are needed. Examples of such methods and devices are discussed in the present disclosure.

Within examples, a method includes processing an input signal using a finite element model (FEM) to generate an output signal. The input signal, the output signal, and the FEM are associated with a simulated additive manufacturing process. The method also includes adjusting the input signal based on comparing the output signal to a reference signal, and thereafter processing the input signal using the FEM to generate the output signal.

The input signal (e.g., a discrete time signal) generally represents control settings for the simulated AM process at a given point in time. In a PBF example, the input signal can take the form of a power setting, a scan speed, a target location, and/or a heating time for an energy beam (e.g., a laser beam or an electron beam) that is used to fuse selected portions of a powder precursor material into a formed component. Additionally or alternatively, the input signal could represent a powder flow rate, that is, a rate at which new layers of powder are deposited onto the powder bed during the process for formation of additional portions of the component.

FEM is a numerical method for solving boundary value problems involving partial differential equations that characterize phenomena such as heat transfer, thermal stress, and fluid flow. As such, an FEM can be applied to predict the results of a simulated additive manufacturing process, More specifically, the FEM is used to generate the output signal based on the input signal. For instance, the FEM predicts how the powder material reacts to the energy beam characterized by the input signal.

The output signal generally represents results of the simulated AM process at a given point in time and/or at a given position within the precursor material. In a PBF example, the output signal can represent physical characteristics of a melt pool of the powder bed. The melt pool refers to an area or volume of the powder bed that has been fused together to form a portion of the component. As such, the output signal can represent a width of a melt pool, a depth of the melt pool, an area of the melt pool, and/or a volume of the melt pool (e.g., at a given point in time). Additionally or alternatively, the output signal could represent a thermal stress, a temperature (e.g., average or peak temperature), a shape, or a porosity of the powder bed at particular locations.

As described above, the input signal is adjusted based on comparing the output signal (e.g., an observed width of a melt pool) to a reference signal (e.g, a target width of the melt pool). For example, a proportional-integral-differential (PID) controller and/or a repetitive control algorithm can be used to adjust the input signal based on a difference between the output signal and the reference signal.

Conventionally, FEM can take hours or even days to simulate the printing of a few layers of a component that occurs in a few seconds in reality. Thus, it has been Challenging to integrate FEM with closed-loop control that can be implemented in real-time. Embodiments disclosed herein can enhance the FEM processing such that it can be implemented with real time closed-loop control.

This disclosure includes an iterative bi-directional computation where FEM and feedback controls are updated at equal time intervals (e.g., Tₛ). Therein, the FEM output signal is processed by the feedback control to generate a new input signal. Then the new input signal is sent back to the FM and a new FEM calculation (also with computation time Tₛ) begins. In this manner, step by step, we implement the FEM and synchronize the time scale between FEM and feedback control.

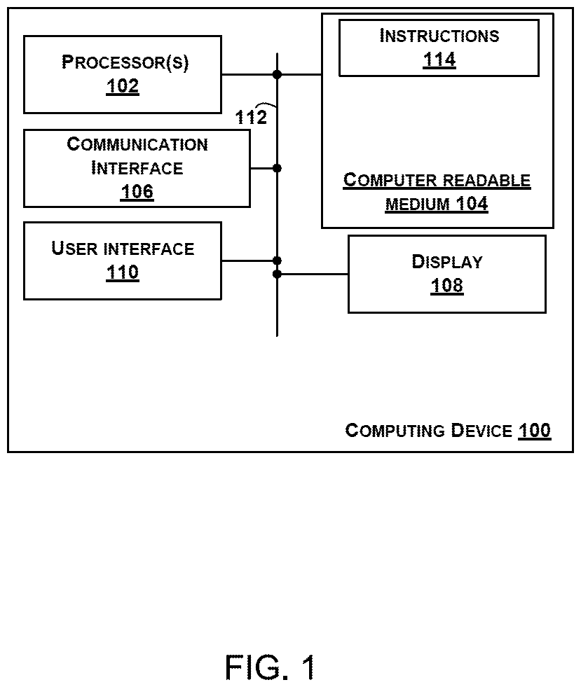

FIG. 1 shows the computing device 100. The computing device 100 includes one or more processors 102, a non-transitory computer readable medium 104, a communication interface 106, a display 108, and a user interface 110. Components of the computing device 100 are linked together by a system bus, network, or other connection mechanism 112.

The one or more processors 102 can be any type of processor(s), such as a microprocessor, a digital signal processor, a multicore processor, etc., coupled to the non-transitory computer readable medium 104.

The non-transitory computer readable medium 104 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc. read-only memory (CD-ROM) among other devices used to store data or programs on a temporary or permanent basis.

Additionally, the non-transitory computer readable medium 104 can be configured to store instructions 114. The instructions 114 are executable by the one or more processors 102: to cause the computing device 100 to perform any of the functions or methods described herein.

The communication interface 106 can include hardware to enable communication within the computing device 100 and/or between the computing device 100 and one or more other devices. The hardware can include transmitters, receivers, and antennas, for example,. The communication interface 106 can be configured to facilitate communication with one or more other devices, in accordance with one or more wired or wireless communication protocols. For example, the communication interface 106 can be configured to facilitate wireless data communication for the computing device 100 according to one or more wireless communication standards, such as one or more Institute of Electrical and Electronics Engineers (IEEE) 801.11 standards, ZigBee standards, Bluetooth standards, etc. As another example, the communication interface 106 can be configured to facilitate wired data communication with one or more other devices.

The display 108 can be any type of display component configured to display data. As one example, the display 108 can include a touchscreen display. As another example, the display 108 can include a flat-panel display, such as a liquid-crystal display (LCD) or a light-emitting diode (LED) display.

The user interface 110 can include one or more pieces of hardware used to provide data and control signals to the computing device 100. For instance, the user interface 110 can include a mouse or a pointing device, a keyboard or a keypad, a microphone, a touchpad, or a touchscreen, among other possible types of user input devices. Generally, the user interface 110 can enable an operator to interact with a graphical user interface (GUI) provided by the computing device 100 (e.g., displayed by the display 108).

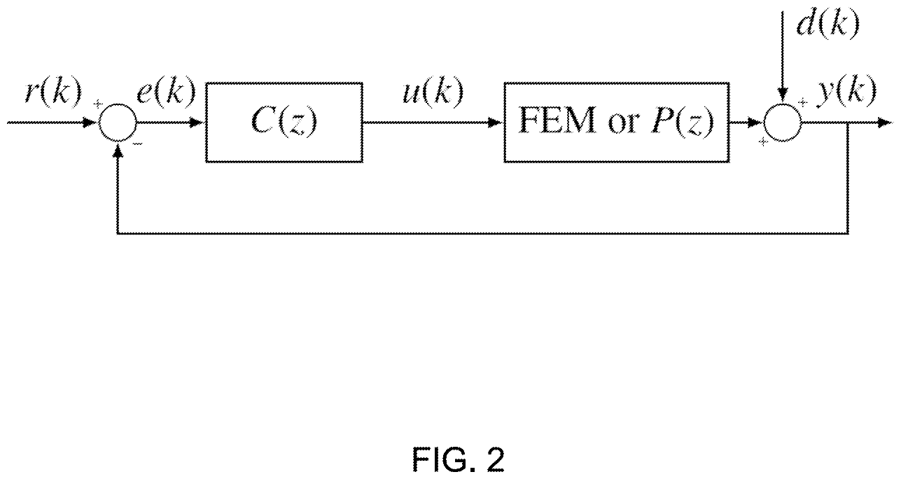

FIG. 2 is a block diagram of a simulated AM process using closed-loop control. Multiple instances of the computing device 100 can simulate the AM process in concert. For instance, a first computing device 100 can use the FEM P(z) and the input signal u(k) to generate the output signal y(k), and a second computing device 100 can use the output signal y(k) and the reference signal r(k) to adjust the input signal n(k), In other examples, a. single instance of the computing device 100 performs all functions. z is the complex indeterminate in the Z-transform, and k is a non-negative integer.

Herein, when a single instance of the computing device 100 is described as perfuming a function, it is also intended that multiple instances of the computing device 100 could alternatively perform the same function in concert.

More specifically, the computing device 100 processes the input signal u(k) using the FEM P(z) to generate the output signal y(k). The input signal u(k), the output signal y(k) and the FEM P(z) are associated with the simulated additive manufacturing process, as described in further detail below. Additionally, the computing device 100 adjusts the input signal u(k) based on comparing, the output signal u(k) to the reference signal r(k). More specifically, the computing device 100 calculates an error signal e(k) that is equal to a difference of r(k) and y(k) (eg., r(k) minus y(k)) and processes the error signal e(k) using the control algorithm C(z) to generate the input signal u(k). Thereafter the computing device 100 processes the input signal u(k) using the FEM P(z) to generate the output signal y(k), and the feedback loop continues.

FIG. 2 shows an input disturbance signal d(k) that represents in-process output signal variations such as melt pool width variations. The input disturbance signal d(k) is shown as externally added to generate the output signal y(k), however this is shown this way merely for emphasis. In actuality, the input disturbance signal d(k) is generated as part of the output of the FEM P(z), that is, the input disturbance signal d(k) is a periodic variation within the output signal y(k) that the described methods aim to alleviate.

The input. signal u(k) can represent one or more of a power setting, a scan speed, a target location, or a heating time of an energy beam such as a laser or an electron beam. Additionally or alternatively, the input signal u(k) represents a powder flow rate, that is, a thickness per unit time at which powder is introduced into the powder bed during processing.

The output signal y(k) can represent one or more of a width, a depth, an area, or a volume of a melt pool. Additionally or alternatively, the output signal y(k) can represent one or more of a thermal stress, a temperature (e.g., average or peak), a porosity, or a shape of the powder material or the formed component.

In some examples, the computing device 100 processing the input signal u(k) using the FEM P(z) includes using the input signal u(k) to numerically determine temperatures of respective positions within the powder bed and/or formed component after an energy beam has been applied to the powder bed according to the input signal u(k), that is, according to a power setting, a scan speed, a target location, or a heating time of the energy beam indicated by the input signal u(k). Additionally, the computing device 100 can numerically determine the temperatures, stress, and/or fluid flow of the respective positions within the powder bed and/or formed component based on the powder flow rate indicated by the input signal u(k).

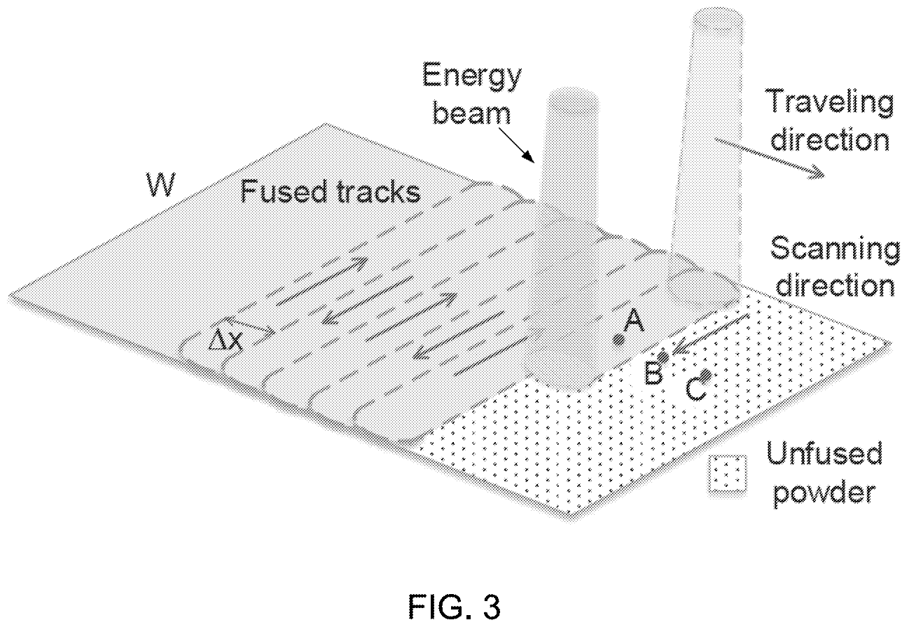

FIG. 3 shows how the input signal u(k) can define the trajectory of the energy beam. As shown, the energy beam has a hatch spacing Δx defined by the input signal u(k) and follows a back and forth snake-like trajectory defined by the input signal u(k).

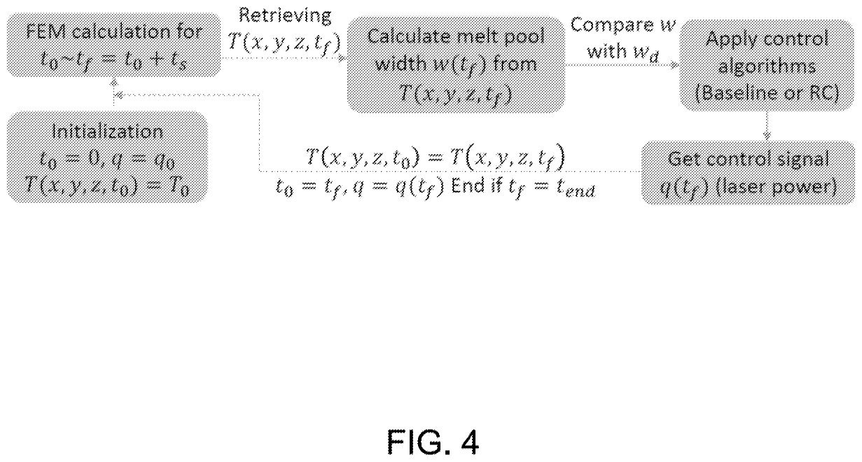

FIG. 4 shows an iterative example of using the FEM P(z) and feedback control to regulate the simulated additive manufacturing process. To begin, the process is initialized via the computing device 100 setting the time t₀ to 0, the initial energy beam power q to g₀, and the temperature T(x, y, z, t₀) to T₀ (at discrete locations defined by the FEM throughout the powder bed). Next, the computing device 100 uses the FEM P(z) to calculate T(x, y, z, t_{f}) (at discrete locations throughout the powder bed) and thereby calculate a melt pool width w(t_{f}) at time t_{f}. In this example, the output signal y(k) represents the time-dependent melt pool width w(t). As such, the computing device 100 calculates the error signal e(k) by subtracting the output signal y(k), which is equal to w(t_{f}) at time t_{f}, from the reference signal r(k), which is equal to w_{d}. The computing device 100 then processes the error signal e(k) using the control algorithm C(z) to generate the next discrete value of the input signal u(k+1), which is equal to the power of the energy beam q(t_{f}) in this example.

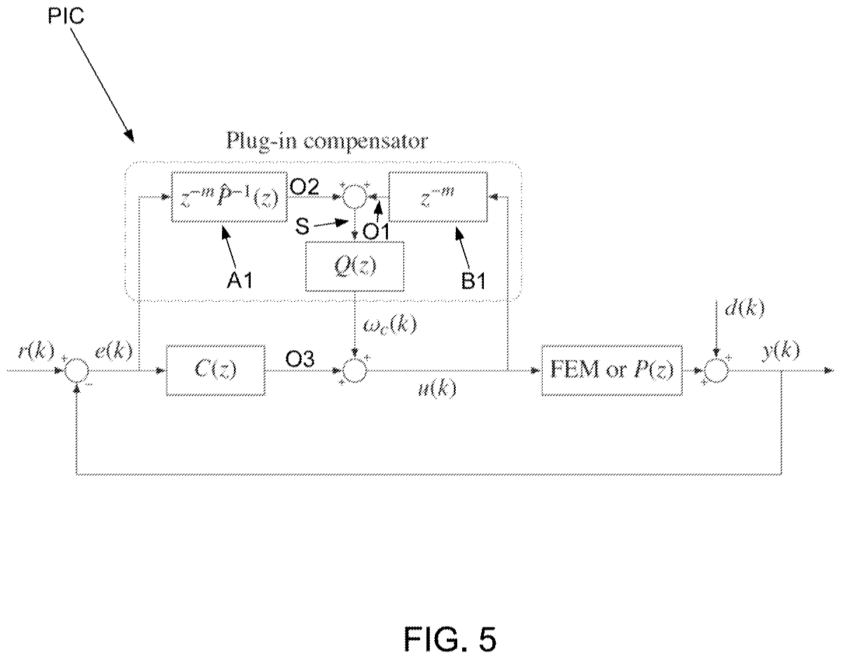

FIG. 5 is a block diagram of a simulated AM process using another closed-loop control algorithm. The computing device 100 processes the input signal u(k) using the FEM P(z) to generate the output signal y(k). Additionally, the computing device 100 adjusts the input signal u(k) based on comparing the output signal y(k) to the reference signal r(k). More specifically, the computing device 100 calculates an error signal e(k) that is equal to a difference of r(k) and y(k) (e.g, r(k) minus y(k)) and processes the error signal e(k) using the control algorithm C(z).Thereafter, the computing device 100 processes the input signal u(k) using the FEM P(z) to generate the output signal y(k), and the feedback loop continues.

A key difference from the closed-loop control algorithm shown in FIG. 2 is that, in FIG. 5, the computing device 100 also provides the error signal e(k) to the plug-in compensator algorithm (PIC). The PIC constitutes what is known as a “repetitive control” algorithm that is well suited for compensating for periodic disturbances. More specifically, the computing device 100 processes the error signal e(k) using a sub-algorithm A1 of the plug-in compensation algorithm (PIC). The sub-algorithm A1 includes a first lag compensator z^{-m} and an inverse plant compensator P⁻¹(z), the inverse plant compensator P⁻¹(z) having a first transfer function that is an inverse of a second transfer function of a nominal model of the FEM P(z).

More specifically, the computing device 100 processes the error signal e(k) using the first lag compensator z^{-m} to delay the error signal by a number of samples m that is equal to a relative degree of the second transfer function of the nominal model of the FEM P(z).

Additionally, the computing device 100 provides the input signal u(k) to a second lag compensator B1 of the plug-in compensation algorithm PIC to delay the input signal u(k) by the number of samples m that is equal to the relative degree of the second transfer function of the nominal model of the FEM P(z).

The computing device 100 also generates a sum S of a first output O1 of the second lag compensator B1 and a second output O2 of the sub-algorithm A1. The computing device 100 generates a compensation signal ω_{c}(k) by processing the sum S using a filter Q(z). When m=1, Q(z) has a transfer function

$$Q ( z ) = \frac{( 1 - {α}^{N} ) {z}^{m - N}}{1 - {α}^{N} {z}^{- N}} ,$$

wherein 0≤α≤1, N is a period of the disturbance within the output signal d(k), and m is equal to the relative degree of the second transfer function of the nominal model of the FEM P(z).

In another example, the computing device 100 generates the compensation signal ω_{c}(k) by processing the sum S using a filter Q(z) having a transfer function

$$Q ( z ) = \frac{( 1 - {α}^{N} ) {z}^{m - N}}{1 - {α}^{N} {z}^{- N}} {q}_{lpf} ( {z}^{- 1} ) {q}_{lpf} ( z ) ,$$

wherein 0≤α≤1, N is a period of the disturbance within the output signal d(k). q_{lpf} is a low pass filter, and m is equal to the relative degree of the second transfer function of the nominal model of the FEM P(z). As an example,

$${q}_{lpf} = \frac{{( 1 + z )}^{{n}_{0}}}{{2}^{{n}_{0}}} ,$$

where n₀ is a non-negative integer.

The error signal e(k) is additionally provided to the control algorithm C(z), which can also be referred to as a baseline control algorithm. In various examples, the baseline control algorithm C(z) includes one or more of a proportional-integral-derivative control algorithm, an H-infinity loop-shaping control algorithm, or a lead-lag compensator. As such, the input signal u(k) is equal to a sum of the compensation signal ω_{c}(k) and the output O3 of the baseline control algorithm C(z). Generally, the process of FIG. 5 is iterative and is repeated over many time cycles.

Various examples include adjusting time-dependent input signals (e.g., one or more of a power setting, a scan speed, a target location, or a heating time of an energy beam such as a laser or an electron beam, or a powder flow rate) for a real additive manufacturing process by evaluating results of the simulated additive manufacturing process and performing the real additive manufacturing process using the time-dependent input signals.

Additionally or alternatively, the computing device 100 performs the simulated additive manufacturing process in one or more simulated experiments and confirms that output variations of the one or more simulated experiments do not exceed a threshold value. For example, the computing device 100 could determine that the output signal y(k) does not vary by more than +/−5% from the reference signal r(k). In this context, performing the real additive manufacturing process includes the computing device 100 performing the real additive manufacturing process based on confirming that the output variations of the one or more simulated experiments do not exceed the threshold value.

In some examples, the computing device 100 can use material parameters, boundary conditions, and/or equations defining physical laws to process the input signal u(k).

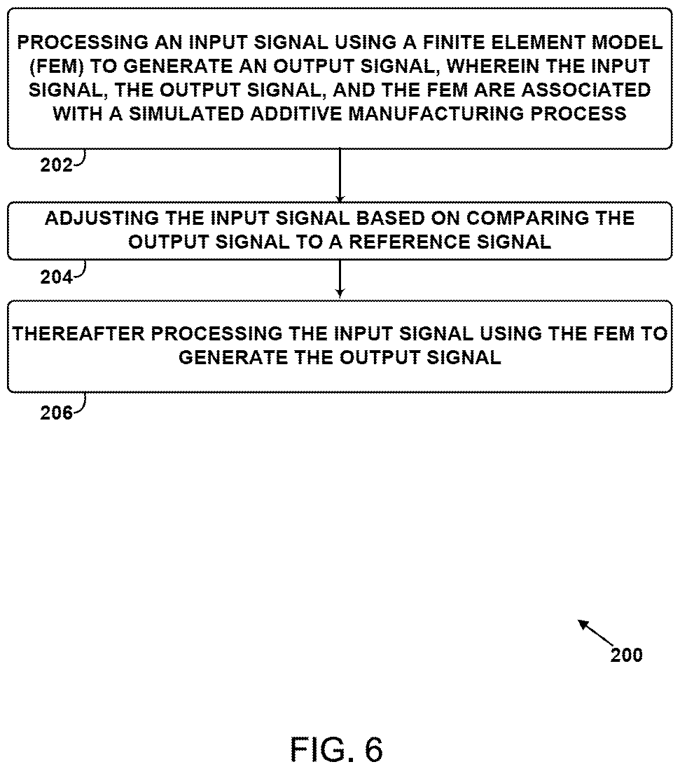

FIG. 6 is a block diagram of a method 200. The method 200 and related functionality can be performed by one or more instances of the computing device 100, for example. As shown in FIG. 6, the method 200 includes one or more operations, functions, or actions as illustrated by blocks 202, 204, and 206. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 202, the method 200 includes processing the input signal u(k) using the finite element model (FEM) P(z) to generate the output signal y(k). The input signal u(k), the output signal y(k), and the FEM P(z) are associated with a simulated additive manufacturing process.

At block 204, the method 200 includes adjusting the input signal u(k) based on comparing the output signal y(k) to the reference signal r(k).

At block 206, the method 200 includes thereafter processing the input signal u(k) using the FEM P(z) to generate the output signal y(k).

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. A method comprising:
processing an input signal using a finite element model (FEM) to generate an output signal, wherein the input signal, the output signal, and the FEM are associated with a simulated additive manufacturing process;
adjusting the input signal based on comparing the output signal to a reference signal; and
thereafter processing the input signal using the FEM to generate the output signal.

2. The method of claim 1, wherein the input signal represents a powder flow rate or one or more of a power setting for an energy beam, a scan speed for the energy beam, a target location for the energy beam, or a heating time for the energy beam.

3-6. (canceled)

7. The method of claim 1, wherein the output signal represents one or more of a width of a melt pool, an area of the melt pool, a volume of the melt pool, an average temperature of the melt pool, a shape of the melt pool, a peak temperature of the melt pool, a depth of a melt pool, a thermal stress of a material, a liquid flow velocity of the material, a temperature of the material, or a porosity of a manufactured component.

8-15. (canceled)

16. The method of claim 1, wherein processing the input signal using the FEM comprises using the input signal to numerically determine temperature, stress, and/or fluid flow of respective positions within a powder bed after an energy beam has been applied to the powder bed according to the input signal.

17. The method of claim 1, wherein adjusting the input signal comprises adjusting the input signal based on an error signal representing a difference between the output signal and the reference signal.

18. The method of claim 17, wherein adjusting the input signal comprises processing the error signal using a baseline control algorithm.

19. The method of claim 18, wherein the baseline control algorithm includes a proportional-integral-derivative control algorithm, an H-infinity loop-shaping control algorithm, or a lead-lag compensator.

20-21. (canceled)

22. The method of claim 18, wherein adjusting the input signal further comprises processing the error signal using a sub-algorithm of a plug-in compensation algorithm, the sub-algorithm including a first lag compensator and an inverse plant compensator, the inverse plant compensator having a first transfer function that is an inverse of a second transfer function of a nominal model of the FEM.

23. The method of claim 22, wherein processing the error signal comprises processing the error signal using the first lag compensator to delay the error signal by a number of samples that is equal to a relative degree of the second transfer function.

24. The method of claim 23, wherein adjusting the input signal further comprises providing the input signal to a second lag compensator of the plug-in compensation algorithm.

25. The method of claim 24, wherein adjusting the input signal further comprises processing the input signal using the second lag compensator to delay the input signal by the number of samples that is equal to the relative degree of the second transfer function.

26. The method of claim 25, wherein adjusting the input signal further comprises generating a sum of a first output of the second lag compensator and a second output of the sub-algorithm.

27. The method of claim 26, wherein adjusting the input signal further comprises generating a compensation signal by processing the sum using a filter having a transfer function
$$Q ( z ) = \frac{( 1 - {α}^{N} ) {z}^{m - N}}{1 - {α}^{N} {z}^{- N}}$$
when m=1, wherein 0≤α≤1, z is the complex indeterminate in the z-transform, Nis a period of a disturbance within the output signal, and m is equal to the relative degree of the second transfer function.

28. The method of claim 26, wherein adjusting the input signal further comprises generating a compensation signal by processing the sum using a filter having a transfer function
$$Q ( z ) = \frac{( 1 - {α}^{N} ) {z}^{m - N}}{1 - {α}^{N} {z}^{- N}} {q}_{lpf} ( {z}^{- 1} ) {q}_{lpf} ( z ) ,$$
wherein 0≤α≤1, z is the complex indeterminate in the z-transform, N is a period of a disturbance within the output signal, q_{lpf} is a low pass filter, and m is equal to the relative degree of the second transfer function.

29. The method of claim 28, wherein the input signal is equal to a second sum of the compensation signal and an output of the baseline control algorithm.

30. The method of claim 1, further comprising:
adjusting time-dependent input signals for a real additive manufacturing process by evaluating results of the simulated additive manufacturing process; and
performing the real additive manufacturing process using the time-dependent input signals.

31. The method of claim 30, further comprising:
performing the simulated additive manufacturing process in one or more simulated experiments; and
confirming that output variations of the one or more simulated experiments do not exceed a threshold value,
wherein performing the real additive manufacturing process comprises performing the real additive manufacturing process based on confirming that the output variations of the one or more simulated experiments do not exceed the threshold value.

32-33. (canceled)

34. A computer readable medium storing instructions that, when executed by a computing device, cause the computing device to perform functions comprising:
processing an input signal using a finite element model (FEM) to generate an output signal, wherein the input signal, the output signal, and the FEM are associated with a simulated additive manufacturing process;
adjusting the input signal based on comparing the output signal to a reference signal; and
thereafter processing the input signal using the FEM to generate the output signal.

35-99. (canceled)

100. A method comprising:
processing an input signal using a finite element model (FEM) to generate an output signal, wherein the input signal, the output signal, and the FEM are associated with a simulated additive manufacturing process;
adjusting the input signal based on comparing the output signal to a reference signal;
thereafter processing the input signal using the FEM to generate the output signal;
adjusting time-dependent input signals for a real additive manufacturing process by evaluating results of the simulated additive manufacturing process; and
performing the real additive manufacturing process using the time-dependent input signals.

101-133. (canceled)

134. The method of claim 1, wherein processing the input signal using the FEM comprises using material parameters, equations defining physical laws, and/or boundary conditions to process the input signal.
